(19) United States
(12) Patent Application Publication
(10) Pub. No.: US 2008/0048979 A1
(43) Pub. Date: Feb. 28, 2008

(54) Optical Method and Device for use in Communication

(75) Inventor: Steven E. Ruttenberg, Tel-Aviv (IL)

Correspondence Address: Martin D. Moynihan;PRTSI, P.O.Box 16446, Arlington, VA, 22215, US

(73) Assignee: Xolan Enterprises Inc., Road Town (VG)

(21) Appl. No.: 11/631,478

(22) PCT Filed: Jul. 8, 2004
(86) PCT No.: PCT/IL04/00614

§ 371 Date: Jan. 4, 2007

Related U.S. Application Data
(60) Provisional application No. 60/485,942, filed on Jul. 9, 2003.

(51) Int. Cl. G09G 5/00; H04N 1/46

(52) U.S. Cl. 345/158; 345/156; 345/166; 345/168; 345/173; 358/509

(57) ABSTRACT

A method and device are presented enabling communication between two or more parties. A pattern input at a first party side is identified and data indicative of the input pattern is generated. This data is used to operate an illumination process to create an illuminated pattern, indicative of the input pattern, on at least one plane exposed to at least one of said two or more party sides.

### FIELD OF THE INVENTION

This invention relates to an optical method and device, which is particularly useful in communication.

### BACKGROUND OF THE INVENTION

Optical pointers have been developed and widely used. The earliest optical pointers used tiny incandescent bulbs, a lens, and mask or transparency to project a dot or arrow. Such pointer devices were about as big as a full size (D-cell) flashlight, required a separate power pack attached by wires, and probably plugged into the wall. Performance of such devices was limited since the beam could not be collimated as well as a laser, but nonetheless was a major advance over the stick. However, since these devices used an incandescent lamp, any color was possible using optical filters though given the brightness or lack thereof, white was most common.

U.S. Pat. No. 4,200,367 discloses a non-laser projector for a film transparency having a first housing for enclosing an image transmitting system and a second housing having an open end through which the illumination from a projection bulb supported within the second housing is adapted to pass. The first and second housings are adjustably coupled to each other such that when they are located in juxtaposed position the illumination from the bulb is directed into the first housing so as to project an image of the transparency film along an optical path defined by the transmitting system onto a rear projection screen mounted in one wall of the first housing. When the two housings are spaced from each other, the illumination from the lamp may be advantageously utilized for nonphotographic purposes, e.g., reading. Preferably, the rear projection screen is pivotally mounted to the first housing such that it may be moved out of alignment with the optical path thereby enabling the image to be projected onto a remote viewing surface.

The first laser-based pointers used helium-neon (HeNe) lasers with their high voltage power supplies packaged as compactly as possible, but still required a separate power pack or bulky case which included heavy batteries.

The development of inexpensive visible laser diodes significantly contributed into the development of optical pointer device. Laser diode device is known as the combination of a semiconductor chip that does the actual lasing along with a monitor photodiode chip (used for feedback control of power output) housed in a package (usually with three leads) that looks like a metal can transistor with a window in the top. These are then mounted and may be combined with a driver circuitry and optics in a diode laser module or the common laser pointer. Diode lasers use nearly microscopic chips of Gallium-Arsenide or other semiconductor materials operable to generate coherent light in a very small package. The energy level differences between the conduction and valence band electrons in these semiconductors provide the mechanism for laser action. Laser diodes are now quite inexpensive and widely available. The most common types found in popular devices like CD players and laser pointers have a maximum output in the 3 to 5 mW range. Laser diodes are only slightly larger than a grain of sand, run on low voltage low current, and can be mass produced—originally driven by the CD player/CDROM revolution, barcode scanners, and other applications where a compact low cost laser source is needed. Pointers are commonly available with red or green beams, and at 3 mW or 5 mW of power.

Laser pattern heads and generators have also been developed and are widely used. Pattern heads are either built-in (selected by a thumb-wheel type arrangement) or are in the form of interchangeable tips that slip over the end of the pointer. Passing the laser beam through a pattern head provides for projecting patterns, in the form of arrows, stars, squares or many other pre-designed shapes. Slightly more sophisticated, though less versatile, are the pattern generators which create elliptical patterns. Such a laser toy is sensitive to motion, and when the toy is rocked or shaken, the laser beam path is pushed on a resonant frequency in two directions, which persists beyond the initial shaking to create changing elliptical shapes on surfaces.

Patent publication WO 03/036553 discloses an arrangement for and method of projecting an image on a viewing surface, utilizing sweeping a light beam along a plurality of scan lines that extend over the viewing surface, and selectively illuminating parts of the image at selected positions of the light beam on the scan lines. The viewing surface can be remote from a housing supporting the arrangement, or can be located on the housing.

### SUMMARY OF THE INVENTION

There is a need in the art to facilitate communication between people by providing a novel optical method and portable device, capable of projecting user-input graphics, and enabling communication between people at two or more sides by presenting (displaying) at one side the graphic information input at another side.

The term “graphics” or “graphics pattern” used herein actually signifies any picture, scheme, text, etc. that can be “input” by movement (e.g., hand drawing), typing via a keypad, selected from previously stored graphics information via a user interface utility, image acquisition, etc. It should be noted that the term “graphics input”, especially when considering its use for sharing, downloading, and storing for future use, also refers to efficiently transmitted processed digital instructions or data.

The present invention takes advantages of the general principles of a laser pointer, and provides for sensing an input pattern (graphics) to operate an illumination or projection process accordingly to thereby enable displaying an illuminated pattern indicative of the sensed input pattern. This allows communication between people at two or more sides by presenting (displaying) at one side the graphic information input at another side.

The term “communication” used herein signifies projection of visual patterns from one side, where the pattern is created (input), to at least one other side where the pattern is viewed. It should be noted that the pattern may be viewed at the first side or from the first side as well. It should also be noted that the term “created” used herein not necessarily signifies actual patterning (drawing) carried out at the first side, but may also refer to reception of a certain graphics input at the first side by the device of the present invention. Generally, the first side is not necessarily the side where the pattern (graphics) is created, but may actually be the side where the graphics is input (e.g., received from a remote side) and is projected to be viewed to the device user. Thus, the terms “first side” and “second side” are referred to two sites where the graphics pattern is, respectively, input and projected.

The device of the present invention can be used similar to a standard pen, in that it can be held in the hand and manipulated to as if to draw, trace or write text or graphics according to the users intentions and abilities. Additionally or alternatively, graphics (e.g., text) may also be downloaded/uploaded from an external or attached device, or typed via an integrated keypad into the device memory. The user has the option to use the device to project what has been recorded onto a surface, for example by means of rapid deflection or manipulation of a laser beam path.

A “surface” or “plane” on which a pattern is projected or displayed is a surface of any geometry, whether flat or not, may and may not be stationary, may be a surface of a certain object (e.g., a person's back), and may be a “virtual” surface in air space.

Thus, according to one broad aspect of the present invention, there is provided a method for use in communication between two or more parties, the method comprising: identifying a pattern input at a first party side and generating data indicative of the input pattern, and using said data indicative of the input pattern for operating an illumination process to create an illuminated pattern, indicative of said input pattern, on at least one surface exposed to at least one of said two or more party sides.

The identifying of the pattern may include identifying the pattern created as a certain motion (e.g., user's motion while drawing or a motion while scanning certain graphics. The pattern to be projected may be created by user's actuation of a touch screen or keypad, or user's operation of a computer mouse. Generally, the motion pattern may be identified (sensed) using one of the following: a roller balls system, joystick/pointing stick system, a touch pads system or pressure sensitive display system, an optical sensing system, an imaging system, a gyros and accelerometers system, and a keypad system.

Preferably, the pattern identification includes filtering the pattern features to select only the features that are to be included in the illuminated pattern.

The operation of the illumination process may include operating a light manipulation system (e.g., deflection system) to direct one or more light beams in accordance with the input pattern.

Alternatively, the operation of the illumination process may include operating a spatial light modulator (SLM) to affect a light beam passing therethrough in accordance with the input pattern to thereby produce an output light pattern of the SLM indicative of the identified input pattern, or operating a matrix of light sources in accordance with the input pattern to thereby produce an output light pattern (structured light).

Preferably, the data indicative of the identified input pattern is stored and used to operate the illuminating process so as to create high-frequency repetitions of the illuminated pattern on the projection surface such that these repetitions are substantially not noticeable to the human eye.

According to another aspect of the invention, there is provided a method for use in communication between two or more parties, the method comprising: identifying an input motion pattern created at a first party side and generating data indicative of the input pattern; and using said data indicative of the input pattern for operating an illumination process to create an illuminated pattern, indicative of said input motion pattern, on at least one surface exposed to at least one of said two or more party sides.

According to yet another aspect of the invention, there is provided a method for projecting a pattern, the method comprising: identifying a pattern input in a communication device, generating data indicative of the input pattern, and using said data indicative of the input pattern for operating an illumination process to create an illuminated pattern, indicative of said input pattern, on at least one plane exposed to the device user.

According to yet another aspect of the invention, there is provided a method for use in communication between two or more parties, the method comprising: identifying a pattern input at a first party side and generating data indicative of the input pattern, and using said data indicative of the input pattern for operating an illumination process to create an illuminated pattern, indicative of said input pattern, and to project the illuminated pattern on at least one surface exposed to at least one said two or more party sides with high frequency repetitions of said illuminated pattern such that said repetitions are substantially not noticeable to the human eye.

According to yet another aspect of the invention, there is provided a device comprising: a sensing unit accommodated at a first party side and operable to identify a pattern input at the first side and generate data indicative of the input pattern; an illumination unit configured and operable to create at least one light pattern; and a control unit connectable to the sensing unit and to the illumination unit, the control unit being configured and operable for receiving the data indicative of the input pattern and generating operating data to operate the illumination unit to create the at least one illuminated light pattern indicative of said input pattern on at least one surface exposed to at least one second party side, the device thereby enabling communication between the first and second parties.

There is also provided according to yet another broad aspect of the invention, a device comprising a sensing unit configured for identifying an input motion pattern created at a first party side and generating data indicative of the input motion pattern; an illumination unit configured and operable to create at least one light pattern; and a control unit connectable to the sensing unit and to the illumination unit, the control unit being configured and operable for receiving the data indicative of the input motion pattern and generating operating data to operate the illumination unit to create the at least one illuminated light pattern indicative of said input pattern on at least one surface exposed to at least one second party side, the device thereby providing for communication between the first and second parties.

According to yet another broad aspect of the invention, there is provided a device comprising a sensing unit configured for identifying an input pattern created at a first party side and generating data indicative of the input pattern; an illumination unit configured and operable to create at least one light pattern; and a control unit connectable to the sensing unit and to the illumination unit, the control unit being configured and operable for receiving the data indicative of the input pattern and generating operating data to operate the illumination unit to create the at least one illuminated light pattern, indicative of said input pattern, and project said at least one illuminated pattern, with high frequency repetitions of said illuminated pattern such that said repetitions are substantially not noticeable to the human eye, onto at least one surface exposed to at least one second party side.

According to a further aspect of the invention, there provided a communication device configured for data exchange with other communication systems via a communication link, the device comprising: a sensing unit configured and operable to identify a graphics pattern in a message input to the communication device and generate data indicative of the input pattern; an illumination unit configured and operable to create at least one light pattern; and a control unit connectable to the sensing unit and to the illumination unit and being configured and operable for receiving the data indicative of the input pattern and generating operating data to operate the illumination unit to create the at least one illuminated light pattern indicative of said input pattern and output said at least one illuminated pattern towards at least one surface.

The present invention also provides a mobile phone device comprising: a sensing unit configured and operable to identify a graphics pattern in a message input to the mobile phone device and generate data indicative of the input pattern; an illumination unit configured and operable to create at least one light pattern; and a control unit connectable to the sensing unit and to the illumination unit and being configured and operable for receiving the data indicative of the input pattern and generating operating data to operate the illumination unit to create the at least one illuminated light pattern indicative of said input pattern and output said at least one illuminated pattern towards at least one plane.

The input pattern may be that input by a user of the communication device, a pattern received at the device via a communication link, or a pattern selected by the device user from pre-stored graphics.

### BRIEF DESCRIPTION OF THE DRAWINGS

In order to understand the invention and to see how it may be carried out in practice, preferred embodiments will now be described, by way of non-limiting examples only, with reference to the accompanying drawings, in which:

FIG. 1A is a block diagram of a device according to the invention;

FIG. 1B is a flow diagram of a method according to the invention;

FIG. 2 is a schematic illustration of a hand held (pen-like) device of the present invention;

FIG. 3 illustrates another example of the device of the present invention utilizing a touch screen;

FIG. 4 illustrates a mobile phone device configured according to the invention;

FIGS. 5A to 5C schematically illustrate three examples, respectively, of the illumination unit configuration suitable to be used in the device of the present invention;

FIG. 6 illustrates the principles of “blanking” (data filtering) aspect of the present invention used when crating data indicative of an input motion pattern to be illuminated/projected;

FIG. 7 illustrates an example of the device of the present invention;

FIG. 8 illustrates an example of the device of the present invention utilizing a light deflection system having separate deflectors for X- and Y-axes deflections;

FIG. 9 schematically illustrates another configuration of a light deflection system suitable to be used in the device of FIG. 8; and

FIG. 10 illustrates yet another example of the device of the present invention.

### DETAILED DESCRIPTION OF THE INVENTION

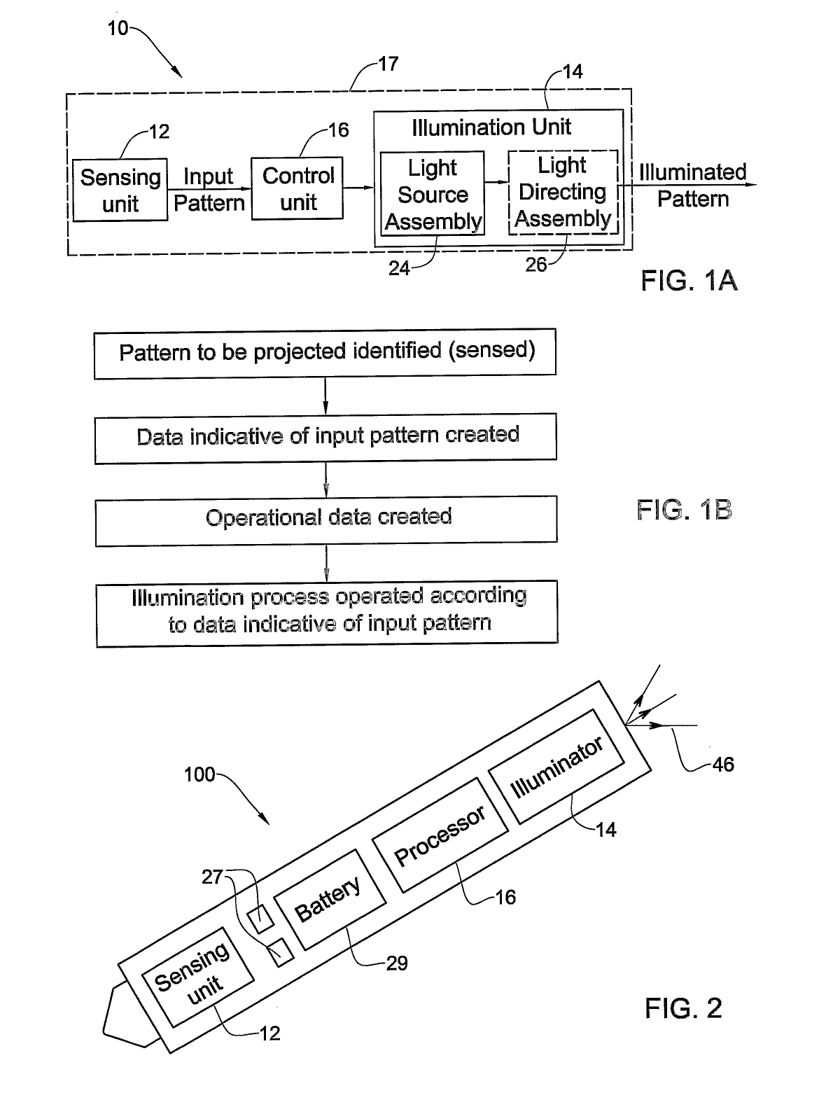

Referring to FIG. 1A, there is illustrated, by way of a block diagram, a device 10 according to the invention. The device 10 is configured as the so-called “laser drawer” operable as a communication device, wherein the communication between two or more sides is achieved by projecting an input pattern created by the device 10 at the first side (e.g., by first user) to a certain plane or surface exposed to the second side (second user). As indicated above, the term “created” not necessarily signifies actual patterning (drawing) carried out at the first side, but may also refer to reception of a certain graphics input (e.g., text) by the device 10.

The device 10 includes a sensing unit 12, an illumination unit 14, and a control unit (CPU) 16 for operating the illumination unit 14 in accordance with data coming from the sensing unit 12. The sensing unit 12 may be incorporated in a common housing 17 (preferably a hand held housing, for example shaped like a pen) carrying the illumination and control units, or may be associated with one or more external sensor.

The sensing unit 12 is configured to detect a pattern created at the first side, and to generate data indicative of the detected pattern (input pattern). Accordingly, the sensing unit 12 includes one or more appropriately designed sensor, and may also include as its constructional part a processor configured and operable to translate the sensed data into a pattern of coordinates, or alternatively such a processor may be part of the control unit 16.

Generally, input pattern is indicative of graphics, such as picture or text. This may be graphics created (e.g., “drawn”) by the user's operation of the device (e.g., device motion, or typed keypad); or “pre-existing graphics” that are previously saved, downloaded, shared, etc.

According to one embodiment of the invention, a pattern indicative of graphics to be projected is that of a motion carried out by the individual's limb or by an object which is in physical contact with the individual. It should be understood that the sensing of motion may be implemented with and without direct contact with the moving object (e.g., individual's limb), for example motion of the individual' hand over a mobile phone may be sensed by equipping the phone device with a triangulating system of sensors. Generally speaking, in this embodiment the input pattern indicative of certain graphics is created as a motion pattern.

The sensing unit 12 is thus configured for sensing a motion or graphics input and generating data indicative thereof. For example, the motion pattern is created by a movement of the entire device 10, e.g., a user moves the pen-like device 10 while “drawing” a picture to be presented (projected) to him and/or to another user, and thus the sensing unit 12 just identifies its own motion. The sensing unit 12 is capable of detecting direction and distance of travel effected by the user or another object whose motion is going to be projected. Alternatively, the sensing unit 12 can detect the effected force or acceleration and its direction. The sensing unit 12 can utilize at least one of roller balls, touch pads (finger or stylus), optical sensing technology, gyros and accelerometers, joystick-like buttons or pads to sense direction and force, and other suitable known techniques, as will be described more specifically further below.

The control unit 16 is typically a computer device (chip with embedded application (e.g., vector/raster graphics algorithms) preprogrammed for processing and analyzing data coming from the sensing unit 16 and being indicative of the detected pattern (e.g., motion pattern). The control unit 16 receives the pattern-related data (input pattern) and generates output data to operate the illumination (or projection) unit 14 to enable generation of an illuminated (projected) pattern indicative of the input pattern.

The illumination unit 14 includes a light source assembly 24 that is configured for generating either a single light beam or a plurality of light beams; and, depending on the light source assembly configuration, may also include a light directing assembly 26 shown in the figure in dashed lines. Several examples of the configuration of the illumination unit 14 will be described more specifically further below.

FIG. 1B illustrates a flow diagram of a method according to the invention. First, a pattern to be projected is identified (sensed), and data indicative of such an input pattern is created. The pattern identification may consist of detecting a motion carried out by a user (e.g., actual movement or typing), or may consist of scanning a pre-existing graphics. This data indicative of the input pattern is processed and analyzed to generate operational data to thereby operate an illumination process in accordance with the data indicative of the input pattern.

The communication device 10 of the present invention is preferably configured as a hand held device operable to detect a motion effected by the device user (first party) and to operate the illumination unit accordingly to present an illuminated pattern, indicative of this motion, on a surface or plane to be visualized by a second party. In such a way, the first party (user) communicates with the second party (another user). The first party may for example be an instructor, a lecturer, or just a person, and the second party may be any relevant audience or second person. The first party who operates the device 10 is the one to communicate with the second party. An example for such communication is a lecturer during art lesson, taking place in a yard. The lecturer is moving his index finger in the air, while a light beam produced in the device 10 is stirring an illumination pattern indicative of the finger's motion on a wall exposed to the audience or second person.

FIG. 2 exemplifies a hand held communication device 100 of the present invention. To facilitate understanding, the same reference numbers are used for identifying components that are common in all the examples of the invention. The device 100 has a pen-like housing 17 carrying a sensing unit 12; an illumination unit 14; and a control unit 16. Also provided in the device 100 are power source 29 (battery arrangement) and user interface unit 27 (buttons) allowing the user to operate the device.

The sensing unit 12 is configured for sensing the motion of the device 100 while being moved by a user and generating measured data (input pattern) indicative of the so-created motion pattern. The control unit 16 receives the measured data and processes it to generate output data for operating the illumination unit 14. Light 46 exiting the device 100 (i.e., light produced by the illumination unit) is indicative of a pattern to be presented at a remote plane (projecting surface). This illuminated pattern presents a picture indicative of that created as a result of the device movement.

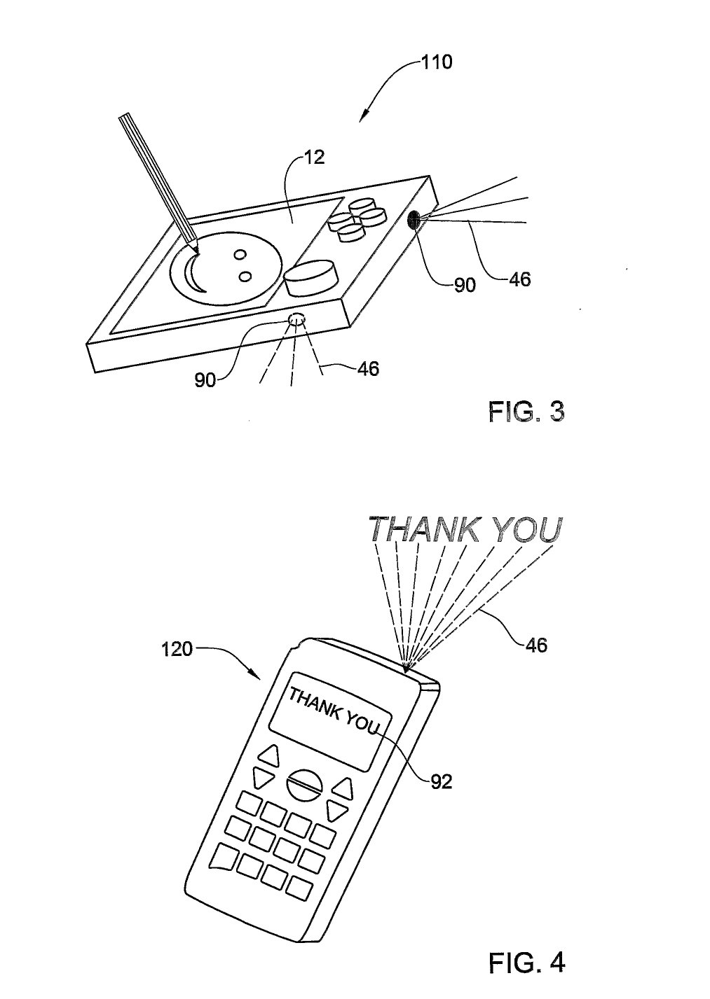

Reference is made to FIG. 3 schematically illustrating another example of a device according to the invention. The device, generally designated 110, includes an internal motion input unit (a sensing unit) 12 in the form of a graphic touch screen, on which a user draws his input pattern (graphics) by a stylus. The device also includes illumination and control units which are not shown here. Light 46, indicative of the drawn pattern, outputs the device 110 via an aperture 90. The device 110 may be employed when a user wishes to project graphics onto a surface in front of him, and probably to see the projected picture concurrently while drawing it. The device is preferably configured to provide absolute positioning and a format for review and editing of new (drawn) or stored graphics.

The device of the present invention may be configured to project the same picture onto more than one plane. To this end, the illumination unit is configured to define more than one path of light indicated of the sensed pattern (input pattern). This may be implemented using a light separating unit (e.g., a beam splitter) in the optical path of light coming from the light source assembly, to produce two or more light portions indicative of the input pattern and direct these light portions towards two or more light directors, respectively. As shown in the example of FIG. 3, two identical light patterns 46 concurrently propagate from the device 110 in different directions towards two different projection planes. It should be noted, although not specifically shown, that projection onto two or more different planes may be selectively implemented, i.e., the device normally operating in the single-projection mode and being selectively operable in the multiple-projection mode. To this end, the beam separating unit may be controllably shiftable between its operative and inoperative positions, e.g., movable with respect to the optical path of a laser beam coming from a laser source. It should also be noted that the multiple-projection mode may be implemented using multiple illumination sub-units, each including a laser source assembly and possible also a light directing assembly. In this case, the control unit operates each of the illumination sub-units in accordance with the same data indicative of the input pattern.

The present invention may be used in a variety of applications, for example in a mobile phone device. FIG. 4 shows a mobile phone device 120, which, in addition to all the functional elements typically included in the mobile phone device, is configured for carrying out the present invention, namely include a sensing unit, an illumination unit and a control unit (chip with embedded application), which are not specifically shown. The sensing unit is configured and operated to detect an input text pattern 92 (generally, graphics) and generate data indicative of the input pattern. It should be noted that the pattern to be identified is that input or selected by a phone user (using the phone keypad or touch screen), or the pattern received in the phone device while being generated at another communication system. In the latter case, the sensing unit is capable of identifying the pattern presented on the phone display or digital data indicative of the received graphics. By this, a phone message (for example, an SMS), either a received one or one which is to be transmitted from the phone device, may be projected/displayed as output light pattern 46 exiting the phone device via an appropriately provided output port. The sensing unit (not shown) may contain any known suitable sensor(s), e.g., accelerometers to sense movement, or may be constituted by a graphics pad of its display unit and a stylus (including even a fingernail) used to input graphics. Some examples of the accelerometer configuration are described in the following U.S. Pat. Nos.: 4,945,765; 5,006,487; 5,447,067; 6,581,465; 6,705,166; 6,750,775.

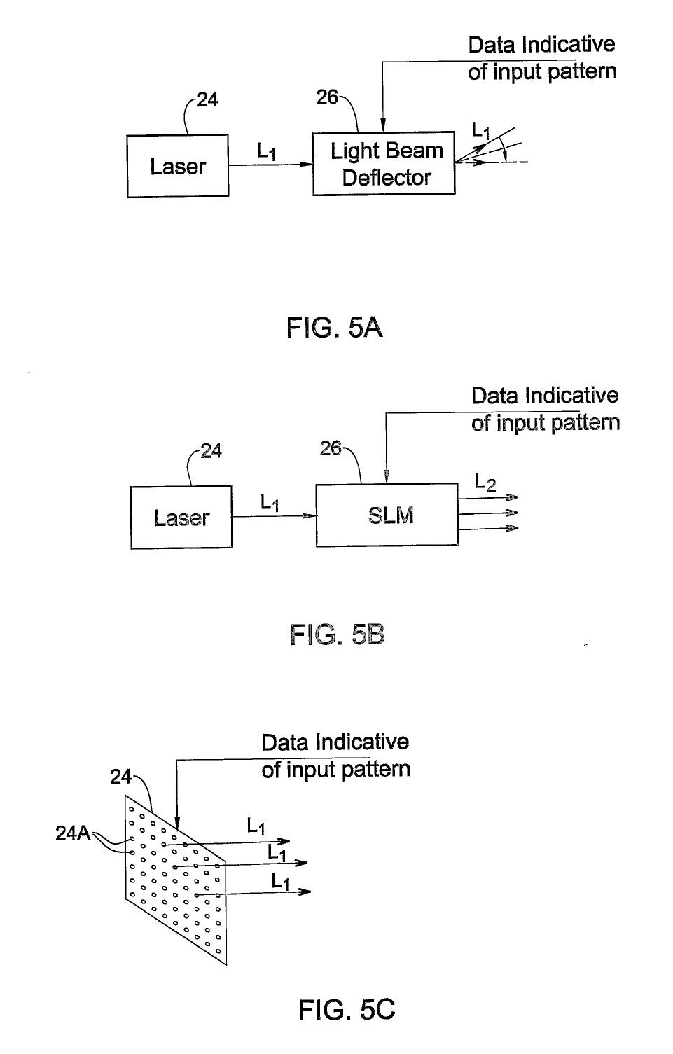

Reference is made to FIGS. 5A-5C showing three specific but non-limiting examples, respectively, of the illumination unit 14 suitable to be used in the device of the present invention. In the example of FIG. 5A, the illumination unit utilizes manipulation of a single laser beam in accordance with the input pattern (e.g., motion pattern or input graphics). The illumination unit 14 includes a laser source 24 generating a laser beam L₁, and the light directing assembly 26 in the form of a light beam deflector or manipulator for displacing the beam in accordance with the sensed input pattern. Preferably, the input pattern data (measured data) is stored in a memory utility of the control unit (16 in FIGS. 1 and 2) and is then used for operating the illumination unit (the light deflector 26 in the present example) to provide high-frequency repetitions of the laser beam displacement, according to the sensed pattern, such that these repetitions are practically not noticeable to the human eye. Various implementations of the beam manipulation are possible, using the known principles of laser graphics and optical deflection techniques.

Beam manipulation options generally fall into two categories: reflection and transmission, implemented using mirrors, lenses or fibers moved by galvanometers, piezo-electric actuators or MEMS devices. Generally, the beam manipulating arrangement 26 is configured for moving a laser beam along two mutually perpendicular axes quickly and precisely and at a reasonable angle of movement in order to be suitable for the needs of the device. The beam-moving (deflecting) arrangement is selected to meet the requirements for the device size and portability. It is important to note that, whether the chosen beam manipulation option uses reflection or transmission, it may be accomplished using separate manipulators for the X- and Y-axes. Alternatively, any suitable existing technology may be used to allow the beam propagation manipulation using a single reflective or transmission unit performing the manipulation in both the X- and Y-axes simultaneously. Blanking of the beam, for non-displaying positioning movements (as will be described below) may be accomplished in a number of ways. Certain laser sources respond very quickly when turned ON and OFF, and thus blanking may be accomplished at the light source. Alternatively, the beam may remain ON at all times during a graphics projection, but will be blocked using an opaque object mounted so as to be rapidly shifted between its inoperative position (out of the beam path) and operative position (in the beam path). Certain piezo, optic, liquid crystal and MEMS devices and rotating or moving grids are suitable to implement such a task.

It should be noted that the beam may not be entirely blanked, but its intensity may be modified for certain aspects of the drawing. Beam intensity may be modified at the source as well, and/or by shifting a semi-opaque or semi-transparent material between operative and inoperative position (in and out of the beam path). Intensity or beam spread can also be modified by changing the transparency or optical characteristics of certain materials that remain constantly in the beam path.

The beam directing unit 26 may also be designed to optimize laser graphics capabilities (either vector or raster). Generally, laser graphics utilizes programming (operating or manipulating) a laser beam, by means of a computer system, to draw an image that can be projected onto almost any type of surface, presenting the so-called “electronic paint brush”. The so-created images can be animated sequences that zoom, dissolve and rotate. It is known to synchronize the fast moving laser beams (reflecting from an array of mirrors) with music to thereby produce fantastic visual displays of crisscrossing, multi-colored beam patterns. Laser graphics begin with a small dot of laser light. Using tiny scanning mirrors (deflectors), the dot may be moved about very rapidly (in a repeated, or near repeated manner in the case of animation pattern) such that the human eye perceives a solid line of light. Abstract patterns may be created using a stationary beam and special optics.

Laser vector graphics utilizes the parallelism of laser beams: when laser beams strike a surface, the reflection back to individual's eyes appears only as a bright dot of light. Laser images are drawn by guiding a laser beam (and thus a very bright dot) along the path of the original drawing. In order to steer the laser beam along a path, the information about this path is to be defined as a series of horizontal and vertical coordinates, which is accomplished through a digitizing process, e.g., utilizing the so-called “digitizing tablet” device. The latter consist of the following: The original art is placed on the tablet, pin-registered to assure perfect alignment with each successive frame, and traced by hand one line at a time. The locations of key points along these lines are thus entered into the control unit, which then outputs the individual changes along the horizontal and vertical axes as a connect-the-dot list of instructions. To create the final laser image, these X-Y signals are simultaneously output as operating voltages to scanners (deflectors) of the illumination (projection) unit. Each scanner has a mirror mounted on a shaft which can rotate to precise angles based on the input voltage it receives. The scanners are mounted in such a fashion that the laser beam is reflected from the first mirror and then from the second one, providing oscillations along the horizontal and vertical axes, respectively. This provides precise steering of the laser beam to any point on the chosen screen surface. Thus, with the right directions, the original image is re-traced in laser light. If one writes a word with no connecting “line” between the letters, the beam blocking (“blanking”) is utilized (as described below) for the time the laser would be projecting that line, so each letter (or object) appeared to stand by itself. Blanking can be performed with a third scanner, an acousto-optic modulator, or by electronically controlling the laser output as done with semiconductor lasers. Persistence of vision is the only reason the images drawn with laser light appear to exist at all. Otherwise, a static laser image, let alone an animated laser character, would not exist at all. A laser image, after all, is merely a dot of laser light tracing out what is essentially a connect-the-dot picture over and over again, approximately thirty times per second. Without persistence of vision, one would merely see the moving dot. With the benefit of this electro-chemical process, the entire path of the dot is retained. The human eye and brain perceive the image being traced, and not merely the dot which traces it. Thus a single frame can be perceived, and many frames in a row can be sequenced to provide the illusion of motion (animation). This phenomenon begins in the retina of the eye itself. The millions of rods and cones present there are transformers of information. As they are hit with the photons of light reflecting from the rapidly scanning laser beam, their light sensitive pigments are bleached, and an electrochemical signal is generated which travels to the visual cortex. This is the signal which is translated by brain into “vision”. The light sensitive pigments, however, take time to recharge to an unbleached state, and during this time, a signal is still being generated, and propagated to the brain. As a result, an image flashed on a screen will be retained briefly in the retina while the rods and cones recharge. As they recharge, the image perceived by the mind fades. Thus, a bright dot moving along a path leaves a trail of decreasing intensity behind it.

Raster graphics utilizes the same persistence of vision phenomena described above, and represents images not by connecting dots and lines as in vector graphics, but by displaying rows and rows of dots. As with television, dots are closely spaced and displayed in fast repetition. The eye and brain merge the dots and the viewer sees a solid two-dimensional object. Raster graphics can be displayed using the same laser deflection and blanking systems used in vector laser graphics.

Raster graphics excel over vector graphics in their ability to fill a defined area, and to move very quickly. Certain objects are more easily recognized as a filled area, rather than a vector outline. The control unit 16 of the device of the present invention may operate the illumination unit 14 in consideration with this advantage. This can be realized in several ways: (a) upon selection by the user itself; (b) using a look-up table which defines certain circumstances when raster graphics is to be operated rather than vector graphics; using other adaptive algorithms such as neural networks, which can decide, by way of “self” improvement, as to whether to use raster or vector graphics. Circumstances defining when either one of raster and vector graphics is preferred may include parameters of displayed patterns, such as types of shapes, forms, whether it includes single letters or sentences, and parameters related to the environmental conditions in which illumination/projection is to be carried out. In the latter case, the device may include environmental sensor(s), for example a light-meter. In addition, a user can update, in real time, the look-up table in order to improve its sensitivity.

The use of optical deflection provides for affecting the intensity and/or direction of a laser beam. For example, deflecting a fraction of the beam can perform either modulation or deflection. The known optical deflection techniques suitable to be used in the invention include, but are not limited to, acousto-optic modulators, electro-optic and magneto-electro-optic effects; piezo-electric actuators to deflect a beam; rotating prism or mirror to deflect a beam; galvanometer (“galvo”) or solenoid actuators moving mirrors, optic fiber, lenses or prisms, or opaque objects (for blanking); liquid crystal beam steering; microelectromechanical systems (MEMS), scanning micromirrors, comb drive actuators, etc.; as well as DMD/DLP (the Texas Instruments technology), Grating Light Valve, (GLV), inorganic digital light deflection, resonant scanners and mechanical resonant scanners. Piezo electric elements deflect a light beam depending on the voltage supply to these elements. Piezo actuators are very precise, strong, low power consumption, and display extremely fast response times, although suffering from a relatively small scan angle and high expense. Almost any actuator may deflect a beam via mirrors, optic fiber cantilevers, lenses, prisms, or other beam moving materials. Graphics, animations, abstracts and dynamic beam effects are generated by X-Y scanning of the laser beam using galvanometer scanners. The scanners are large (i.e. macroscopic) mechanically controlled mirrors, with limited applicability for small, hand-held devices (e.g., a 3 mm tube galvanometer, commercially available from ABEM, Sweden). For two-dimensional scanning, two perpendicular tubes are used.

Preferably, the beam directing unit of the device of the present invention utilizes deflectors manufactured by solid-state microelectronics technology, MEMS, which enables smaller size, higher performance, and greater functionality of the device. MEMS systems interface with both electronic and non-electronic signals and interact with non-electrical physical world as well as the electronic world by merging signal processing with sensing and/or actuation. An MEMS system deals with moving-part mechanical elements, making miniature systems possible such as accelerometers, fluid-pressure and flow sensors, gyroscopes, and micro-optical devices. MEMS is also widely used to fabricate micro optical components or optical systems such as deformable micromirror array for adaptive optics, optical scanner for bar code scanning, optical switching for fiber optical communication etc. This special field of MEMS is called “Micro-Opto-Electro-Mechanical Systems” (MOEMS). MEMS technology provides for creating two-dimensional scanning mirrors, where a single mirror is controlled in both the X and Y orientations

In the example of FIG. 5B, the illumination unit 14 includes a laser source 24 generating a laser beam L₁, and a light directing assembly 36 in the form of a Spatial Light Modulator (SLM). The construction and operation of an SLM are known per se and therefore need not be specifically described, except to note that the active region of an SLM is defined by a pixel arrangement (matrix of pixels), each pixel being operable to affect a light component passing therethrough, and that SLM may be either of reflective or transmitting type. It should be noted, although not specifically shown, that the illumination unit may include appropriate beam expanding and/or shaping means so as to provide the laser beam cross section corresponding to the dimensions of the active region (pixel arrangement) of the SLM. The SLM is operated by the control unit in accordance with the input pattern to actuate selective pixels of the SLM according to this pattern. Light exiting from the SLM is in the form of a plurality of spatially separated light components (structured light), generally at L₂, indicative together of the pattern (picture) to be projected (displayed).

In the example of FIG. 5C, the illumination unit 14 includes a light source 24 in the form of a two-dimensional array (matrix) of point-like laser sources, generally at 24A, each for generating a laser beam. The laser sources 24A are mounted on a planar support element 24B and are arranged in a spaced-apart relationship. The light source 24 is operated by the control unit to selectively actuate the laser sources, in accordance with data indicative of the input pattern (motion or input graphics), and to produce a plurality of spatially separated light components (structured light), generally at L₁, indicative together of the pattern (picture) to be projected (displayed).

As indicated above, the sensing unit (12 in FIGS. 1 and 2) may utilize any graphics input options. The main consideration for graphics input is whether or not the input comes from an internal motion sensing component, an internal or external keypad or graphics pad, or other internal or external or attached devices.

Some of the standard motion sensing options for use in the device of the present invention include: roller balls, touch pads (finger or stylus), optical sensing technology, gyros and accelerometers, joystick-like buttons or pads to sense direction and force, and many others. Any of these may be used either alone or in combination to sense motion and direction information. Any graphics input systems or combination of such systems used in the device of the present invention is capable of sensing direction and distance of travel (or acceleration).

The sensing unit can be implemented using various configurations. This may be the so-called internal input motion unit, in which case it includes a touch screen, keypad or graphics pad. The sensing unit may utilize sensor(s) of the kind responsive to data coming from an internal imaging device, e.g., a device acquiring images of a moving object (e.g., individual's limb), or a scanner following a certain external pattern. The sensing unit may be designed as an external input motion assembly, being a separate unit, e.g., attached to a moving object to provide data indicative of the object's motion, or configured and accommodated for imaging a moving object or graphics information, for example, utilizing a CCD or scanner. The input pattern can be sensed even far away from the device, appropriately stored, and then input to the device (e.g., via a disc-on-key).

Generally, the type of sensor(s) used in the sensing unit determines the type of motion which can be detected. The motion sensing unit may include motion sensors of different types. For example, the device may include both internal input motion unit in the form of a graphics (touch) screen and a connecting port for connecting to an external motion sensing assembly, and may be operable to selectively actuate either one of the internal and external motion input means.

The motion sensing unit may utilize a computer mouse that is typically used to perform meaningful and useful two-dimensional instructions on a computer screen by direct translation of the manual sliding of a mouse-like input device on a flat surface which mimics the orientation of the screen itself. This may be a mechanical mouse. Such a mouse typically carries a rubber ball slightly protruding from a cage containing two rollers set at right angles. As one rolls the ball across the desktop, it turns the rollers, which in turn send horizontal and vertical positioning information back to the computer, thus enabling the computer to make the mouse pointer on the screen moving left, right, up and down. The construction and operation of such a mechanical computer mouse are known per se and therefore need not be described in more details, except to note that mechanical computer mice come in all shapes and sizes, including some shaped and held like a pen with a small roller ball at the tip. Another type of known mouse suitable to be used in the present invention is an optical mouse, which has no rolling ball. Most of these mice bounce a beam of light from inside the mouse casing to a reflective pad and then back to a sensor on the mouse casing. These optical mice have no moving parts, and they are less subject to mechanical failure, but are limited in their movement to the boundaries of the reflective pad. The motion sensing assembly 12 may utilize the optical navigation technology, such as that used in Microsoft's IntelliMouse, where one or more LED is used to illuminate the features of a surface, and miniature camera receives and processes the image and produces direction/speed data. This technology does not require a reflective pad, in fact almost any surface will suffice. The need for a fixed surface or reference point may be bypassed by measuring the inertia of movement itself, without any limitation of space. Inertial sensing may be performed with two types of sensors: accelerometers which sense translational acceleration, and gyroscopes which sense rotational rate. Together, accelerometers, tilt and pressure sensors, and tiny gyroscopes, can detect exact movements. In particular, micromechanical accelerometers (MEMS technology described above) can be used that are millimeter size devices capable of accurately measuring the motion of a body in one or more dimensions.

It should be noted that graphics input (e.g., via motion sensors) may take place on a surface or in air (using gyros or accelerometers). Movements may be made horizontally, as in most desktop environments, or vertically, as in a wall or blackboard type environment. Surface drawing should preferably be of similar performance for horizontal and vertical surfaces, as for example, a roller ball is capable of moving the same in either case. Air drawing, using three-dimensional accelerometers, for example, provides for processing the input to determine whether the movement is horizontal or vertical at a higher degree. Based on the sensed input pattern, a two-dimensional graphic can be displayed.

It should also be noted that motion to be sensed may be made to reproduce a mental concept, or to trace an existing drawing or graphic by physically tracing the existing drawing or graphic with the moving input device. The device of the present invention may be used as a laser pointer to draw or move the beam point on a surface like a wall to create a drawing or graphic (generally, to create a pattern). The laser point can also be used to trace existing images or objects. The movements required to draw or trace with the laser point can be recorded by the motion sensor and processed for immediate or eventual display projection or upload to a computer for analysis.

As indicated above, graphics input can also be generated by using a light beam (a laser beam) as a two-dimensional scanner. A drawing, especially simple line drawings, or even three-dimensional objects can be scanned, and visual and contrast information sensed for example by an integrated camera. The scan is then processed to determine the best and most efficient (for example, least detailed) way to display the scanned object so that the projection display resembles the original.

As indicated above, the device of the present invention (i.e., creation of the input pattern) may utilize a “blanking” input mechanism. For example, when drawing a word on a graphics program with a mouse, data to be supplied to a computer should distinguish between data indicative of a motion describing a letter (i.e., the motion to be recorded by the computer) and data indicative of a motion that just connects one letter to another (which might not be needed to be displayed).

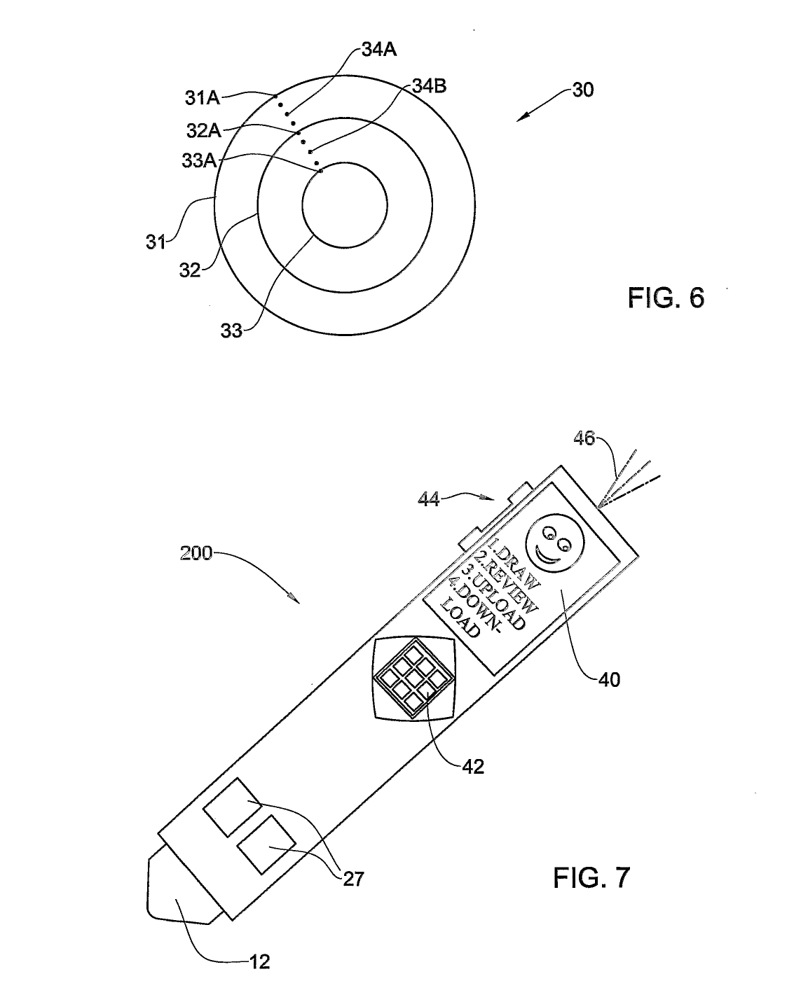

FIG. 6 exemplifies a multiple-circle pattern 30 to be illuminated on a surface (projecting plane). Data indicative of this pattern can be created as follows: A user starts his motion with his index finger at point 31A in space. The motion sensing unit starts sensing this motion. The user first draws circle 31, and when returns to point 31A moves inward along dotted line 34A till point 32A, from which he starts drawings a circle 32 until he returns to point 32A, and moves along a dotted line 34B to point 33A and moves along a circular path 33. Here, motions along dotted lines 34A and 34B are unwanted (passive) and should not be displayed (i.e., should be eliminated from the input pattern data).

Thus, the control unit of the device of the present invention may be preprogrammed to filter the sensed motion-related data to distinguish between active data (to be displayed/projected) and passive data. To this end, the mouse buttons can be used: for example, keeping the button pressed while moving the mouse tells the program that this movement is “active” and should be displayed; and releasing the button tells the program that the current movement (while the button is released) is “passive” and should not be displayed. Thus, generally speaking, the communication device may include user interface means (e.g., buttons) to enable distinguishing between those movements that are and are not to be considered in creating the pattern to be projected. This can be accomplished, like the mouse example, with buttons on the device, pressing the button while moving the device is indicative for the control unit that this is movement intended for pattern creation, and movement with the button released being indicative of positioning information, for example the movement between two letters is not displayed, but is important for determining where the second of the two letters begins in relation to the first. This non-displaying or “blanking” of the laser itself is accomplished in a number of manners, utilizing light beam manipulation (controlling the operation of the illuminator). Blanking input may for example be accomplished in the following manner. The sensor which makes contact with a surface is pressure sensitive, whereby a firm pressure against the surface indicates a movement intended to be used in the pattern creation (in projection or displaying); a softer pressure (but still contact) against the surface indicates movement describing positional information but not movement for display. It should be understood that other methods of inputting blanks while writing on surfaces may be used as well, such as the assumption that fast movements are positional information movements (“passive” movement) and slow movements are “active” to be used in the pattern creation, or vice versa. Blanking using accelerometers or gyros can also be accomplished with buttons as in the mouse-related example and the above described speed-sensing method. Additionally, it should be noted that such a non-surface writing can sense changes in a vertical position: dips or lower movements indicate “active” movement for display, and heights or upper movements indicate positioning (“passive” movement). Additionally, motion sensing can utilize both surface-writing aspects and accelerometer or gyro aspects. For example, a user may draw on a surface, and position is determined by accelerometer. When the device is moving while contacting a surface (e.g., surface or pressure sensor is activated), this indicates “active” (display) movement, while lifting the device off the surface (and the surface sensor) is indicative of position information.

As indicated above, the control unit (16 in FIGS. 1 and 2) is a chip with embedded application preprogrammed to receive the motion information (input pattern) and translate this data into optimal instructions (operational data) for the illumination unit, i.e., for the beam deflector arrangement in the example of FIG. 5A, for the SLM in the example of FIG. 5B, and for the light source assembly in the example of FIG. 5C. This processing algorithm is optimized for the specific motion sensing and laser projecting (illumination) options used in the device, for example optimized for such parameters as a power supply to the actuators, parameters defining a response profile, compensation for limitations or physical characteristics of the particular beam-moving or generating system. Additionally, the sensing unit has its own characteristics which must be taken into consideration when interpreting the sensed input pattern. Additionally, the control unit is capable of interpreting the user's intentions and design instructions for the laser projector (illumination unit) which best match those intentions. It should also be noted that the control unit may be preprogrammed for compressing a projection in the direction of projection if the projection is to be projected on the floor at some distance from the first party such that the second party, who is assumed to be viewing the horizontal floor (display) with a line of site more perpendicular to the floor (display) surface, sees the image at normal dimensions rather than elongated. The amount of compression may be calculated by the device based on the pitch angle of the device (sensed by the device) being held during projection with respect to the projecting surface (floor). A similar modification to the projection can be performed if the display surface is vertical and perpendicular to the line of sight of the second party, but not the first party (the device operator). Also, if the projection is to be made on a vertical surface like a wall, the device (its sensing unit) might be capable of sensing the roll orientation of the device and displaying the projection in the proper orientation, irrespective of the device orientation being held in the hand. Accelerometers can be used to detect jitter and shaking of the unit during projection and modulate the projection to counter the jitter, stabilizing the projection on the surface. Other image stabilizing methods can be used as well. The control unit may be configured and operable to allow the user to change the angle of projection (and therefore the size of the display). It should also be noted that the device may be configured to allow standard display/projection effects, such as pulsed projections, fade-ins and outs, size fluctuations, shaking, rotating, warping, melting, eclipsing, morphing, etc.

Instructions can also be optimized when a user draws words or graphics using movements, the speed, order and direction of which may be best suited for manual writing but may not be best optimized for rapid laser scanning movements; the processing algorithm might decide that a better looking, more efficient result will require projecting movements backwards, or jumping between letters or graphics lines using different positioning/blanking movements or order, or scanning certain graphics horizontally (as in raster graphics).

The user might make very wide strokes, while the laser projection system is not technically capable of accommodating the corresponding angle, or the strength of the laser beam so diluted by a wide projection exceeds the light intensity minimal recommendations. The control unit may operate to reduce the size of a displayed area in accordance with a maximum recommended angle of projection. For example, the desired approach may be to project all drawings at the same angle, every time.

Even with a fixed or maximum angle of projection, the complexity or “fill” of a drawing may result in a dilute or dim image, or will exceed the laser projector speed or cycle time recommendations in order to achieve it. In this case, the angle of projection may be reduced in order to create a better or more aesthetic result. Likewise, if a user inputs a point as the graphic, i.e. does not move the pen or stylus, the processor may decide to allow the point to be displayed, or may decide to broaden the angle and dilute the point, or may interpret the point as a very small circle, and expand a circle shape, for example, to reduce the “danger” of projecting a concentrated point of light.

Laser pointers have been determined to be safe, doctors seeing cases of permanent damage to the eye only if the pointer is held directly into the eye for a period of ten seconds or more. The nature of the laser drawer device of the present invention dilutes the concentration of the laser beam and thus makes it substantially safer than a laser pointer. The control unit in the device of the present invention may operate such that even a point, if input into the sensor unit, will be displayed much more dilute and spread out than a laser pointer point (such as the circle mentioned above). It can be made impossible to keep a narrow beam of laser light directed to the eye, since it is moving around so rapidly and so widely.

It should be noted that the projected image (pattern) need not be static. As the laser beam is cycling through the graphics, small changes from cycle to cycle will appear to the eye to be movement. Thus, the device may be designed to display animation. Animation may be input to the processor by inputting separate frames, as in a traditional animation. Alternatively, two or more images may be merged by the processor using existing merging algorithms and thus produce more “frames” to smooth the animation. Alternatively, or additionally, scrolling marquee may be used to display longer text by displaying a window of, say, a few letters at a time moving across the window. Animations may run once, or may be looped (repeated) for extended projection. The “animation” may also simply be the display of separate images in sequence, not intending to simulate movement. For example, a sentence may be displayed a few words per image, a second or two per image. Frames or images used in these animations or dynamic displays may be inputted in any of the ways described above.

Handwriting recognition analysis may be applied to the graphics input to convert any handwriting to more standard fonts for projection display. Such converted handwriting can then be manipulated with standard editing tools, for example, cutting and pasting and also even spell correction. There might even be a feature for symbol recognition, for example the smiley face and stars, and perhaps user designed recognition macros. A typed text may be recognized and converted to a different font, or typed smileys and other represented text images can be converted to an associated preprogrammed or pre-chosen graphic and appropriately projected.

As indicated above, the motion sensing unit is configured to detect direction and distance of travel effected by the user or another object whose motion is going to be projected, or to detect the effected force or acceleration and its direction. The case may be such that signals indicative of the detected motion directly operate the illumination unit to illuminate a pattern indicative of the motion signals (either one-to-one or after some processing by a mapping algorithm). According to another option, the control unit may carry out a pattern recognition algorithm. This algorithm includes identification of motion, specific patterns in the motion (direct lines, curves), and repetitive patterns (e.g., a circle). Pattern identification can be either ad-hoc or based on pre-determined patterns to be introduced by the user or selected by him from a look-up table. The analysis results or part thereof may be stored for future use, or directly used by the control unit to operate the illumination unit accordingly. It may also be the case that the user creates a pattern, stores it, and then, using the control unit illuminates a second pattern which is a repetition of the first pattern that he created.

Reference is made to FIG. 7 exemplifying a pen-like device, generally designated 200, constructed and operated according to the present invention. The device 200 includes a sensor unit or graphics input 12, illumination and control units (not shown here), and control buttons 27. Also provided in the device is a graphics screen/pad 40 (e.g., LCD) which may serve as an internal input motion utility or for displaying previews of graphics, either the last graphic inputted (e.g., drawn), or a graphic from the memory. A key pad arrangement 42 (multiple buttons) is also provided to allow the user to directly type a text or to scroll through the list of stored graphics and displaying each one on the screen 40. For example, 4-way buttons may be used to choose characters, and a disambiguation system may be employed to speed (and make more accurate) the text entry. When a graphic is chosen, a certain button of the key pad arrangement 42 may be used to select the graphic for projection. It should be noted that such a graphics screen 40 may be part of the basic portable device 200, or may be an element of another device, such as a Palm pilot device, computer or mobile phone serving as a motion input unit for the device 200. In the latter case, device 200 and the external input motion unit may be configured in such a way that data may flow in one or both directions. For example, graphics data may be transferred to the memory of the device 200 (of its control unit) for immediate or later display projection, or vice versa—graphics data may be transferred from the device 200 to the external motion input unit for display, review, modification or other purposes. The device 200 and the separate (external) motion input unit may communicate with one another via wires (or fibers) or via wireless signal transmission (such as BlueTooth technology), or may be attached structurally, e.g., integral within the same unit. To this end, the device is equipped with appropriately designed communication ports 44. The device 200 may also allow for modifying inputted or drawn graphics either by an internal preview and mechanism for modification or a similar mechanism on an external or attached device. For example, the graphic may be previewed as a “vector graphic”. The dots may be selected and moved by stylus or buttons, and the graphic created by these dots is modified accordingly, possibly to create new frames for animation, as described above.

The device 200 may be designed in a linear orientation, where an output laser beam 46 propagates straight from the end of the device 200, opposite to the motion input unit 12, or the beam 46 emanates from the device perpendicular to the lengthwise orientation of the device (L-shaped design, where the beam exits from side of the device).

The device 200 may also include a motion sensor for itself, in order to minimize the resulting unwanted movement or “jiggle” of the device when turning the “record” mode ON and OFF. When a user of the device 200 is ready to start using the internal motion sensing unit (or graphics input) feature, an action must be taken to initiate this operational mode, just as an action must be taken to exit from this mode. “Jiggle” can be minimized in a number of ways, including an easy access to a light pressure button, or a light sensor, at or near the finger of thumb position on the device. Alternatively, the initiation and exit can be assumed using an algorithm in the control unit that assumes the start and end of a graphic movement. Even if the intended graphic is embedded within a larger series of movements, the user may then cut away any unintended or extraneous movements with a graphics display device in order to arrive at the intended graphic. This “record” button may or may not be the same button as the “blanking” button. For example, a long press of the button may indicate an initiation or exit from the “record” mode, while a short press of the same button may indicate that a blanking should start or stop. Blanking and record button conflicts may be avoided in this way, or by assigning either blanking features to the movement interpretation (as described above) or surface pressure sensors (as also described above), and/or record indications to movement processing algorithms. Both extraneous movements and blanking movements can be modified, subtracted or added (as the case may be) after input has been completed, by an integrated or external graphics display device and graphics manipulation methods (for example, passive motion may be represented by different colored lines or dotted lines).

Alternatively, a separate anti-Jiggling device may be used for controlling the internal motion input unit. Such an anti-Jiggling device includes a control unit (CPU) and a transmitter, the communication device being thus equipped with an appropriate signal receiver. A user operates the communication device, and when the “blanking” option is to be used, the user presses a certain button, while a second press of the same button releases the “blanking” mode.

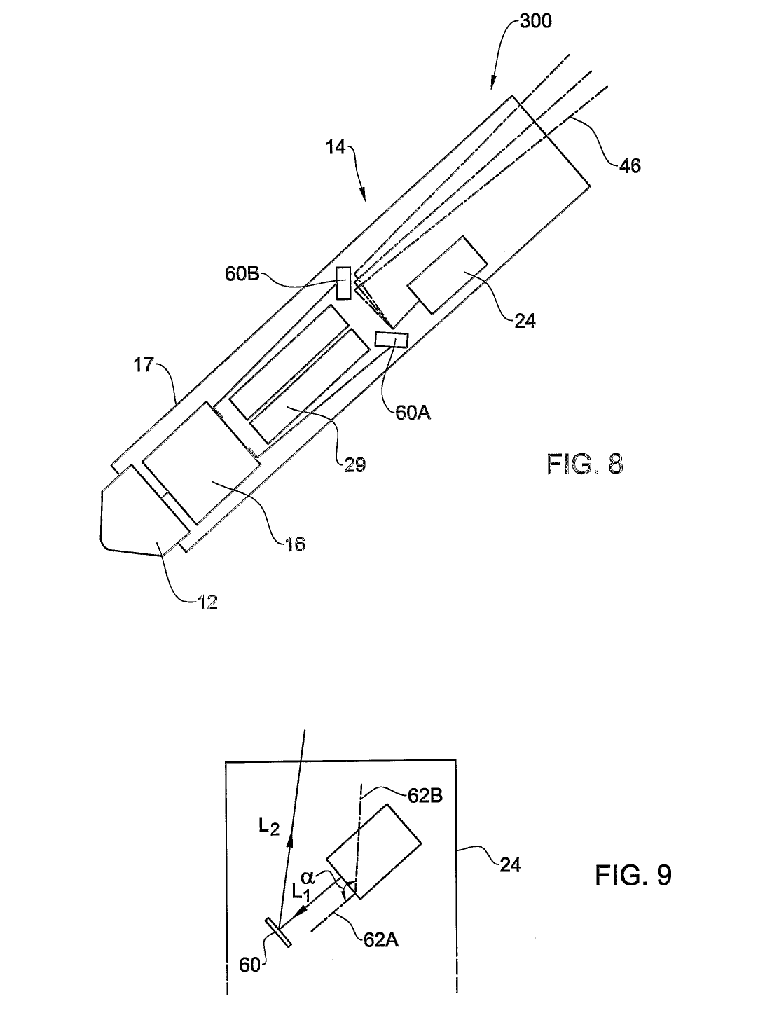

Reference is made to FIGS. 8 to 10 exemplifying devices of the present invention utilizing a light directing assembly based on light deflection. Generally, the beam deflection can be realized by reflection, transmission or a combination of the two modes. Reflection and transmission can be realized using mirrors, lenses or fibers moved by galvanometers, piezo-electric actuators or MEMS devices. Any of these options is capable of deflecting a beam quickly and precisely, and at a reasonable angle of movement in order to be suitable for the needs of the device.

In the examples of FIGS. 8 and 9, a reflection-based deflector arrangement is used. FIG. 8 shows a communication device 300 according to the invention. The device 300 includes a housing 17 designed so as to be conveniently held by user, a motion sensing unit 12, a control unit 16, an illumination unit 14 and a power source 29. In the present example, the illumination unit 14 is designed similar to the above-described example of FIG. 3A, namely, includes a laser source 24, and a light directing assembly 26 in the form of a beam deflector. The beam deflector assembly 26 is configured as a manipulation device using separate units for deflecting a light beam along the X- and Y-axes, respectively. The deflector 26 includes two mirrors 60A and 60B driven (by appropriate actuators which are not specifically shown) for rotation about two mutually perpendicular axes, respectively, thus deflecting the laser beam in two mutually perpendicular directions. In the present example, the laser source 24 and mirrors 60A and 60B are mounted in the so-called “180° back-illumination” configuration, i.e., the laser source 24 emits a laser beam directed towards mirror 60A, which deflects (reflects) the beam to mirror 60B, which in turn deflects the laser beam towards the output from the device direction. Consequently, two spatial degrees of freedom for the movement of the laser beam are established by back-directing. This configuration has the advantage of a smaller footprint.

FIG. 9 exemplifies the use of a single 2-D, X-Y scanning mirror light deflector assembly. As shown, a mirror 60 is used in the “back-illumination” configuration: A beam emitted by a laser source 24 propagates to the mirror 60 along a path 62A which forms an angle α>90° with the desired output beam direction 62B. It should be understood that in order to reduce the footprint, a second stationary mirror can be used similar to the example of FIG. 8, where one of the two mirrors would be stationary and the other would be a 2-D scanning mirror.

The light deflector assembly may be of any known suitable configuration utilizing either one-dimensional or two-dimensional deflectors, for example based on MEMS scanning mirrors. Various examples of MEMS scanning mirror based techniques are disclosed in the following U.S. Pat. Nos.: 6,759,787; 6,598,985; 6,366,414; 6,353,492; and 6,661,637.

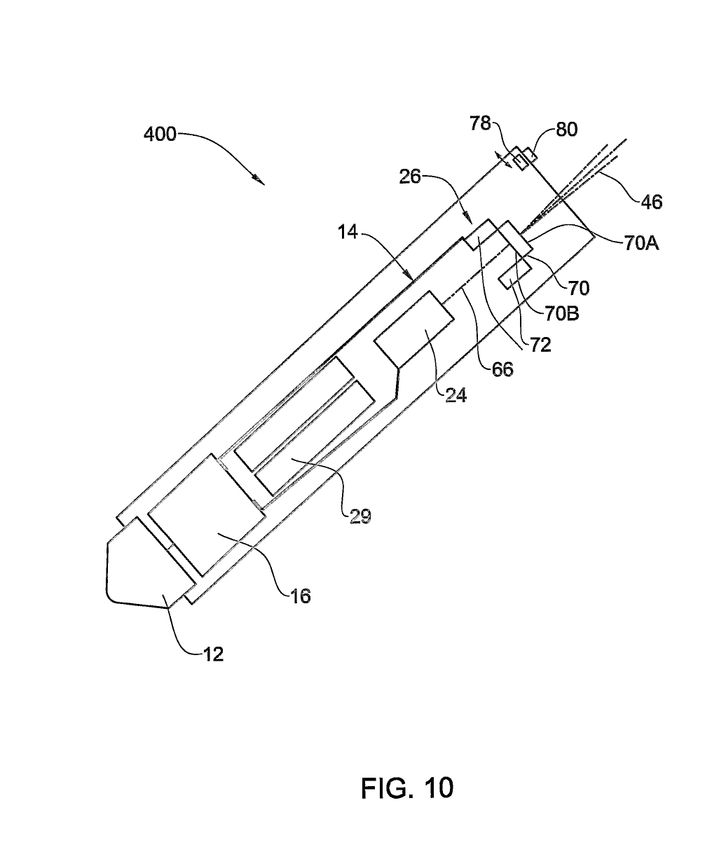

FIG. 10 exemplifies yet another configuration of a communication device 400 of the present invention. The device is configured generally similar to the previously described examples, namely, includes such main constructional parts as a sensing unit 12, an illumination unit 14, and a control unit 16, as well as a power source 29. The illumination unit of device 400 is configured generally similar to the devices shown in FIGS. 5A and 9, namely utilizes a laser source 24 and a light directing assembly 26 in the form of a beam deflector (X-Y scanning transmission optics or scanner). Device 400 distinguishes from the above-described device 300 in that the deflector assembly 26 of device 400 is configured for the beam manipulation using a single transmission unit performing the manipulation in both the X- and Y-axes simultaneously. Additionally, the illumination unit of device 400 has a so-called “forward-illumination” configuration: the laser source 24 is oriented such that a laser beam 66 emitted by the laser source propagates towards an output facet 68 of the device. The laser beam 66 passes through the scanner 26 which operates to deflect the laser beam 66 towards the required direction (according to the input motion pattern). The scanner 26 may include a crystal 70 with unparallel facets 70A and 70B. Variation of an index of refraction of the crystal 70 by application of an external field (e.g., voltage) effects a change in an angle of the axis of propagation of the laser beam 46 exiting the crystal 70 with respect to the input laser beam axis. The frequency of the voltage change is dictated by the control unit 16, based on the input pattern to be illuminated/projected. In order to increase the dynamic range of the output laser beam tilt, the crystal 70 is mounted on an X-Y actuator 72. The crystal may be replaced by a glass plate with unparallel facets (e.g., a prism) mounted for movement by the actuator 72, and the movement of such a glass plate effects the beam deflection. The transmission-based scanner may be of any known suitable configuration, for example based on acousto-optic deflection. An example of acousto-micro-optic deflector is described in U.S. Pat. No. 6,751,009. As indicated above, various techniques can be used to affect the intensity and/or direction of a light beam. Some techniques can be used for both affecting the intensity and the direction of a light beam, and/or to actually implement one function by the other (i.e., deflecting a fraction of the beam can perform either modulation or deflection). Such techniques may utilize acousto-optic modulators, electro-optic and magneto-electro-optic effects, rotating prism or mirror to deflect the beam, or piezo-electric actuators to deflect the beam.

As also indicated above, it might be desirable not to blank the laser beam entirely, but modify the beam intensity for certain aspects of illumination. This may be implemented at the light source, or by moving a semi-opaque or semi-transparent material accommodated in the optical path of the emitted light beam. This is illustrated in FIG. 10, showing a filter 78 mounted for movement so as to be selectively in and out of the optical path of the laser beam. The intensity or the beam spread can also be modified by changing the transparency or optical characteristics of certain materials that remain constantly in the beam path. As also shown as an option in FIG. 10, the light directing arrangement 26 may utilize a shutter 80 mounted for movement across the beam propagation axis and thus selectively block the beam. The movement is fast enough to respond before a new active motion pattern feature is to be illuminated/projected. The moveable shutter 80 may be designed as a rounded iris with a fast response. A moveable shutter may be replaced by an acousto-optic modulator. Such a modulator, when operated, creates in front of the crystal 70 (within a space region of the beam propagation) a drastic change in the index of refraction, and consequently, the beam is blocked. Although in the present example, the filter/shutter is located in the optical path of deflected light, it should be understood that such a filter or shutter may be associated with the laser source, thus affecting the light propagation while on the way to the first mirror (generally, light deflector).

Those skilled in the art will readily appreciate that various modifications and changes may be applied to the embodiments of the invention as hereinbefore described without departing from its scope defined in and by the appended claims.

1. A method for use in communication between two or more parties, the method comprising: identifying a pattern input at a first party side and generating data indicative of the input pattern, and using said data indicative of the input pattern for operating an illumination process to create an illuminated pattern, indicative of said input pattern, on at least one surface exposed to at least one of said two or more party sides.

2. The method of claim 1, wherein said identifying of the pattern comprises identifying the pattern created as a certain motion.

3. The method of claim 1, wherein said identifying of the pattern comprises identifying certain input graphics.

4. The method of claim 3, comprising scanning or tracing the certain graphics and identifying a motion associated with said scanning.

5. The method of claim 1, wherein said identifying of the pattern comprises identifying the pattern created by a certain user's motion.

6. The method of claim 1, wherein said identifying of the pattern comprises identifying user's actuation of a touch screen.

7. The method of claim 1, wherein said identifying of the pattern comprises identifying a displayed pattern.

8. The method of claim 1, wherein said identifying of the pattern comprises identifying digital data indicative of the input pattern.

9. The method of claim 1, wherein said identifying of the pattern comprises identifying user's actuation of a keypad.

10. The method of claim 1, wherein said identifying of the pattern comprises identifying user's operation of a computer mouse.

11. The method of claim 1, wherein said identifying of the pattern comprises filtering the pattern features to select only the features that are to be included in the illuminated pattern.

12. The method of claim 1, wherein the operating of the illumination process comprises operating a light manipulation system to direct at least one light beam in accordance with said input pattern.

13. The method of claim 12, wherein the light directing comprises deflecting the light beam by reflections.

14. The method of claim 1, wherein said operating of the illumination process comprises operating a spatial light modulator (SLM) to affect light passing through the SLM in accordance with said input pattern to thereby produce an output light pattern of the SLM indicative of the identified input pattern.

15. The method of claim 1, wherein said operating of the illumination process comprises operating a matrix of light sources in accordance with said input pattern to thereby produce an output light pattern of said matrix of the light sources indicative of the identified input pattern.

16. The method of claim 1, comprising storing said generated data indicative of the identified input pattern, and using the stored data to operate the illuminating process so as to create high frequency repetitions of said illuminated pattern on said plane such that said repetitions are substantially not noticeable to human eye.

17. A method for use in communication between two or more parties, the method comprising: identifying an input motion pattern created at a first party side and generating data indicative of the input pattern; and using said data indicative of the input pattern for operating an illumination process to create an illuminated pattern, indicative of said input motion pattern, on at least one surface exposed to at least one of said two or more party sides.

18. A method for projecting a pattern, the method comprising: identifying a pattern input in a communication device, generating data indicative of the input pattern, and using said data indicative of the input pattern for operating an illumination process to create an illuminated pattern, indicative of said input pattern, on at least one surface exposed to the device user.

19. A method for use in communication between two or more parties, the method comprising: identifying a pattern input at a first party side and generating data indicative of the input pattern, and using said data indicative of the input pattern for operating an illumination process to create an illuminated pattern, indicative of said input pattern, and to project the illuminated pattern on at least one surface exposed to at least one said two or more party sides with high frequency repetitions of said illuminated pattern such that said repetitions are substantially not noticeable to human eye.

20. A device comprising: a sensing unit accommodated at a first party side and operable to identify a pattern input at the first side and generate data indicative of the input pattern; an illumination unit configured and operable to create at least one light pattern; and a control unit connectable to the sensing unit and to the illumination unit, the control unit being configured and operable for receiving the data indicative of the input pattern and generating operating data to operate the illumination unit to create the at least one illuminated light pattern indicative of said input pattern on at least one surface exposed to at least one second party side, the device thereby enabling communication between the first and second parties.

21. The device of claim 20, wherein the sensing unit is configured for identifying the pattern created as a certain motion.

22. The device of claim 20, wherein the sensing unit is configured for identifying certain input graphics.

23. The device of claim 20, wherein the sensing unit comprises an imaging system.

24. The device of claim 22, wherein the sensing unit comprises an imaging system configured for scanning the certain graphics, and is operable to identify a motion associated with said scanning.

25. The device of claim 20, wherein the sensing unit is configured and operable to identify user's actuation of a touch screen.

26. The device of claim 20, wherein the sensing unit is configured and operable to identify user's actuation of a keypad.

27. The device of claim 20, wherein the sensing unit is configured and operable to identify user's operation of a computer mouse.

28. The device of claim 20, comprising a touch screen, the sensing unit being configured and operable to identify the input pattern resulted from user's actuation of the touch screen.

29. The device of claim 20, comprising a keypad, the sensing unit being configured and operable to identify the input pattern resulted from user's actuation of the keypad.

30. The device of claim 20, being configured as a computer device, the sensing unit being configured and operable to identify the input pattern resulted from user's operation of a computer mouse.

31. The device of claim 20, comprising at least one communication port for receiving data indicative of an input pattern generated at an external sensing unit.

32. The device of claim 20, comprising at least one communication port for receiving input graphics data, said sensing unit being configured and operable to identify a pattern of said graphics and generate the data indicative of the input graphics pattern.

33. The device of claim 20, wherein the control unit is preprogrammed to filter the input pattern features to select only the features that are to be included in the illuminated pattern.

34. The device of claim 20, wherein the sensing unit comprises one of the following: a roller balls system, a touch pads system, an optical sensing system, an imaging system, a gyros and accelerometers system, and a keypad system.

35. The device of claim 20, wherein the illumination unit comprises a light source assembly configured to generate at least one light beam; and a light directing assembly configured and operable by the control unit to manipulate the light beam propagation in accordance with the data indicative of the input pattern.

36. The device of claim 35, wherein the light directing assembly includes at least one light beam deflector.

37. The device of claim 36, wherein the light beam deflector comprises a MEMS system.

38. The device of claim 20, wherein the illumination unit comprises a light source assembly configured to generate at least one light beam; and a light directing assembly including a Spatial Light Modulator (SLM) operable by the control unit to affect the light beam while passing therethrough in accordance with said data indicative of the identified input pattern to thereby produce an output light pattern indicative of the identified input pattern.

39. The device of claim 20, wherein the illumination unit comprises a light source assembly including a matrix of light sources arranged in a spaced-apart parallel relationship, the light source assembly being operable by the control unit to selectively actuate the light sources in accordance with said data indicative of the identified input pattern, to thereby produce a light pattern indicative of the identified input pattern.

40. The device of claim 20, wherein the control unit is preprogrammed to store the data indicative of the identified input pattern and to operate the illumination unit so as to create a high frequency repetitions of said illuminated pattern on said at least one plane such that said repetitions are substantially not noticeable to human eye.

41. The device of claim 20, wherein the sensing unit is accommodated in a common housing with the illumination and control units.

42. The device of claim 41, wherein the sensing unit comprises at least one internal input motion sensor.

43. The device of claim 20, wherein the sensing unit comprises at least one internal input motion sensor.

44. The device of claim 42, wherein said at least one internal input motion sensor is configured to identify a pattern resulted from a motion of the device.

45. The device of claim 42, wherein said at least one internal input motion sensor is configured to identify a pattern resulted from a user's actuation of a touch screen of the device.

46. The device of claim 43, wherein said at least one internal input motion sensor is configured to identify a pattern resulted from a motion of the device.

47. The device of claim 43, wherein said at least one internal input motion sensor is configured to identify a pattern resulted from a user's actuation of a touch screen of the device.

48. The device of claim 20, wherein the sensing unit comprises at least one internal sensor accommodated in a common housing with the illumination and control units, and at least one external sensor, the device comprising at least one communication port for receiving data from said at least one external sensor.

49. The device of claim 20, comprising a user interface utility enabling selection of a pre-stored graphics, the sensing unit being operable to identify the pattern of the selected graphics to thereby create the input pattern for illumination.

50. The device of claim 20, wherein the illumination unit is configured to direct light indicative of the illuminated pattern along at least two spatially separated paths towards at least two different planes.

51. A device comprising a sensing unit configured for identifying an input motion pattern created at a first party side and generating data indicative of the input motion pattern; an illumination unit configured and operable to create at least one light pattern; and a control unit connectable to the sensing unit and to the illumination unit, the control unit being configured and operable for receiving the data indicative of the input motion pattern and generating operating data to operate the illumination unit to create the at least one illuminated light pattern indicative of said input pattern on at least one surface exposed to at least one second party side, the device thereby providing for communication between the first and second parties.

52. A device comprising a sensing unit configured for identifying an input pattern created at a first party side and generating data indicative of the input pattern; an illumination unit configured and operable to create at least one light pattern; and a control unit connectable to the sensing unit and to the illumination unit, the control unit being configured and operable for receiving the data indicative of the input pattern and generating operating data to operate the illumination unit to create the at least one illuminated light pattern, indicative of said input pattern, and project said at least one illuminated pattern, with high frequency repetitions of said illuminated pattern such that said repetitions are substantially not noticeable to human eye, onto at least one surface exposed to at least one second party side.

53. A communication device configured for data exchange with other communication systems via a communication link, the device comprising: a sensing unit configured and operable to identify a graphics pattern in a message input to the communication device and generate data indicative of the input pattern; an illumination unit configured and operable to create at least one light pattern; and a control unit connectable to the sensing unit and to the illumination unit and being configured and operable for receiving the data indicative of the input pattern and generating operating data to operate the illumination unit to create the at least one illuminated light pattern indicative of said input pattern and output said at least one illuminated pattern towards at least one surface.

54. A mobile phone device comprising: a sensing unit configured and operable to identify a graphics pattern in a message input to the mobile phone device and generate data indicative of the input pattern; an illumination unit configured and operable to create at least one light pattern; and a control unit connectable to the sensing unit and to the illumination unit and being configured and operable for receiving the data indicative of the input pattern and generating operating data to operate the illumination unit to create the at least one illuminated light pattern indicative of said input pattern and output said at least one illuminated pattern towards at least one surface.

55. The device of claim 53, wherein said input pattern is that input by the device user.

56. The device of claim 53, wherein said input pattern is that received at the device via a communication link.

57. The device of claim 53, wherein said input pattern is that selected by the device user from pre-stored graphics.
